(19) United States
(12) Patent Application Publication
(10) Pub. No.: US 2013/0290821 A1
(43) Pub. Date: Oct. 31, 2013

(54) Methods and Systems for Generating Shortened Uniform Resource Locators Including Resource Type Identifiers

(71) Applicant: THINMAIL, INC., Sudbury, MA (US)

(72) Inventor: Jordan Pollack, Sudbury, MA (US)

(73) Assignee: THINMAIL, INC., Sudbury, MA (US)

(21) Appl. No.: 13/674,596

(22) Filed: Nov. 12, 2012

Related U.S. Application Data
(60) Provisional application No. 61/640,510, filed on Apr. 30, 2012.

(51) Int. Cl. G06F 17/00

(52) U.S. Cl. 715/208

(57) ABSTRACT

A method for identifying resource types within shortened uniform resource locators includes receiving, by a shortener application executing on a first computing device, from a second computing device, a uniform resource locator and a request to shorten the uniform resource locator. The method includes identifying, by the shortener application, a first identification of a type of a resource within the uniform resource locator. The method includes identifying, by the shortener application, a second identification of the type of the resource, based on the first identification. The method includes generating, by the shortener application, a shortened uniform resource locator including the second identification of the type of the resource. The method includes transmitting, by the shortener application, to the second computing device, the shortened uniform resource locator.

### CROSS-REFERENCE TO RELATED APPLICATIONS

This application claims priority from U.S. Provisional Patent Application Ser. No. 61/640,510, filed on Apr. 30, 2012, entitled “Methods and Systems for Generating Shortened Uniform Resource Locators Including Resource Type Identifiers,” which is hereby incorporated by reference.

### BACKGROUND

The disclosure relates to generating uniform resource locators. More particularly, the methods and systems described herein relate to functionality for generating shortened uniform resource locators including resource type identifiers.

Conventional systems for shortening uniform resource locators provide users with functionality for converting lengthy uniform resource locators into a shorter, more easily shared format. However, such conventional systems typically do not provide users with an identification of a type of resource identified by the uniform resource locators. In such systems, recipients of the shortened uniform resource locators do not typically have a way of determining whether the uniform resource locators will direct them to a desirable resource or to a location containing spam, malware, or otherwise undesirable resources.

### SUMMARY

In one aspect, a method for identifying resource types within shortened uniform resource locators includes receiving, by a shortener application executing on a first computing device, from a second computing device, a uniform resource locator and a request to shorten the uniform resource locator. The method includes identifying, by the shortener application, a first identification of a type of the resource within the uniform resource locator. The method includes identifying, by the shortener application, a second identification of the type of the resource, based on the first identification. The method includes generating, by the shortener application, a shortened uniform resource locator including the second identification of the type of the resource. The method includes transmitting, by the shortener application, to the second computing device, the shortened uniform resource locator.

### BRIEF DESCRIPTION OF THE DRAWINGS

The foregoing and other objects, aspects, features, and advantages of the disclosure will become more apparent and better understood by referring to the following description taken in conjunction with the accompanying drawings, in which:

FIGS. 1A-1C are block diagrams depicting embodiments of computers useful in connection with the methods and systems described herein;

FIG. 1D is a block diagram depicting one embodiment of a system in which a plurality of networks provide data hosting and delivery services;

FIG. 2 is a block diagram depicting an embodiment of a system for identifying resource types within shortened uniform resource locators; and

FIG. 3 is a flow diagram depicting an embodiment of a method for identifying resource types within shortened uniform resource locators.

### DETAILED DESCRIPTION

In some embodiments, the methods and systems described herein provide functionality for identifying resource types within shortened uniform resource locators. Before describing these methods and systems in detail, however, a description is provided of a network in which such methods and systems may be implemented.

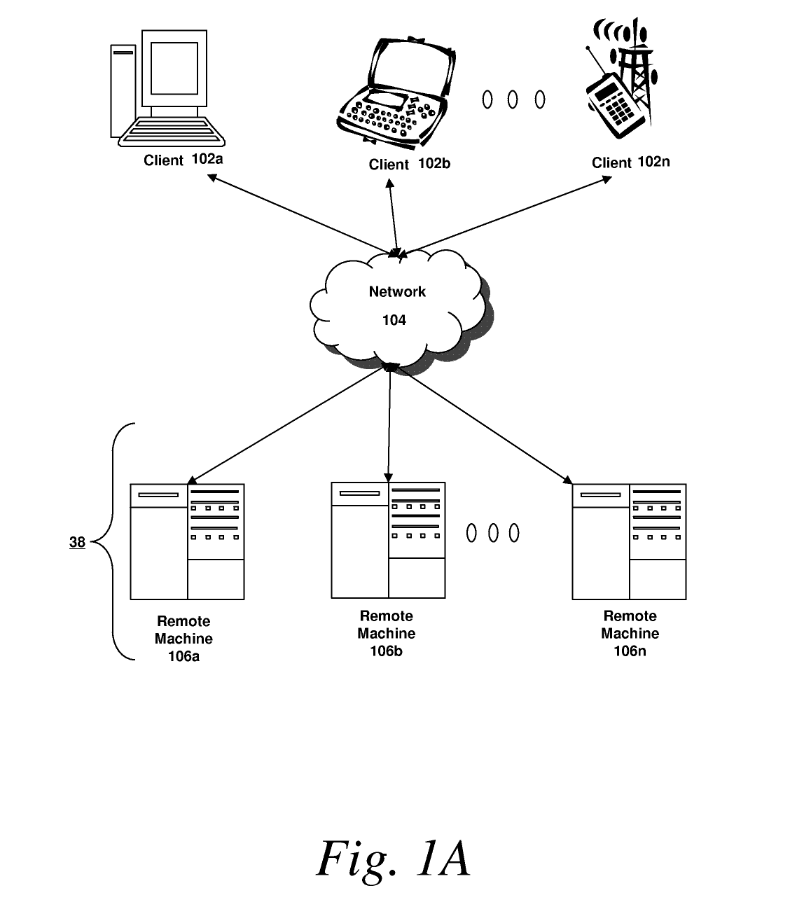

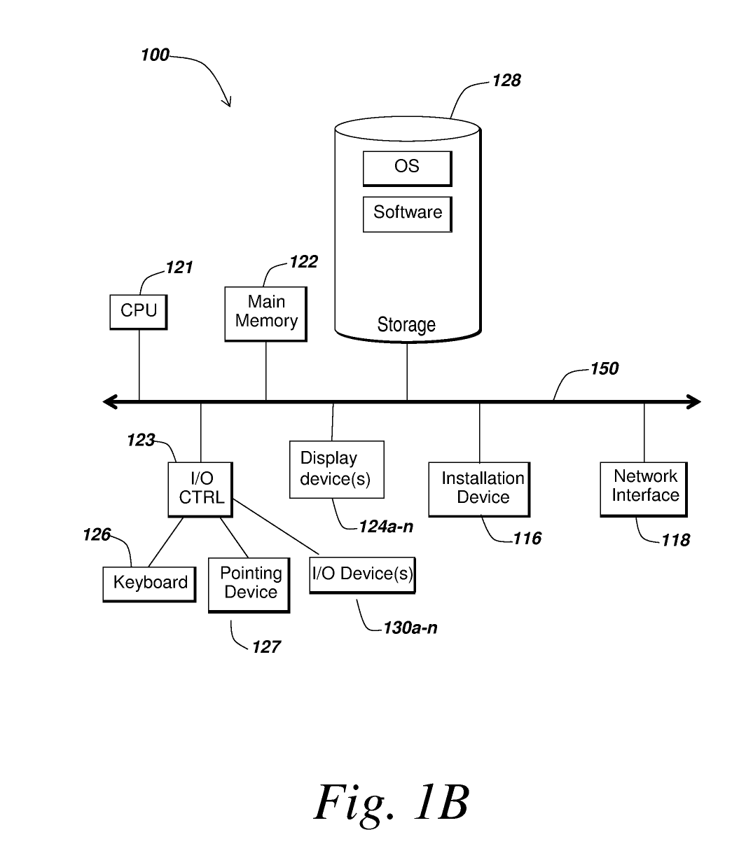

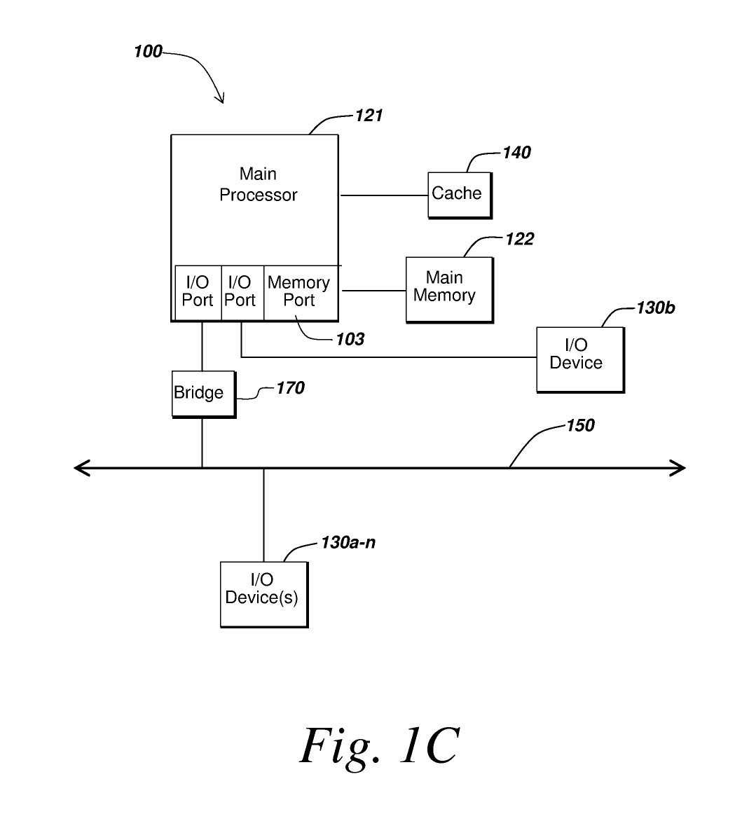

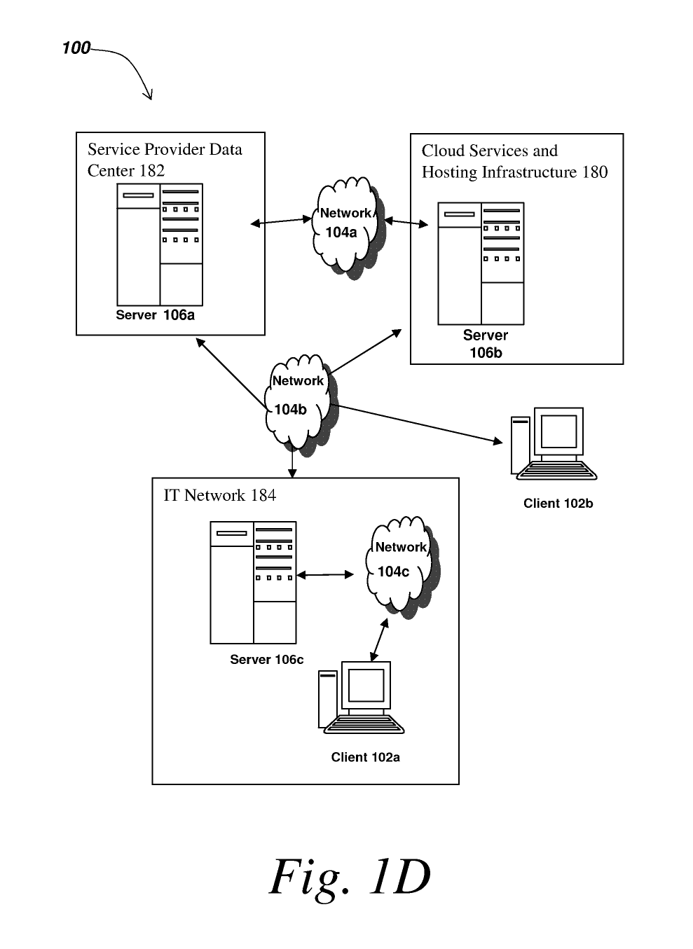

Referring now to FIG. 1A, an embodiment of a network environment is depicted. In brief overview, the network environment comprises one or more clients 102a-102n (also generally referred to as local machine(s) 102, client(s) 102, client node(s) 102, client machine(s) 102, client computer(s) 102, client device(s) 102, computing device(s) 102, endpoint(s) 102, or endpoint node(s) 102) in communication with one or more remote machines 106a-106n (also generally referred to as server(s) 106 or computing device(s) 106) via one or more networks 104.

Although FIG. 1A shows a network 104 between the clients 102 and the remote machines 106, the clients 102 and the remote machines 106 may be on the same network 104. The network 104 can be a local area network (LAN), such as a company Intranet, a metropolitan area network (MAN), or a wide area network (WAN), such as the Internet or the World Wide Web. In some embodiments, there are multiple networks 104 between the clients 102 and the remote machines 106. In one of these embodiments, a network 104′ (not shown) may be a private network and a network 104 may be a public network. In another of these embodiments, a network 104 may be a private network and a network 104′ a public network. In still another embodiment, networks 104 and 104′ may both be private networks.

The network 104 may be any type and/or form of network and may include any of the following: a point to point network, a broadcast network, a wide area network, a local area network, a telecommunications network, a data communication network, a computer network, an ATM (Asynchronous Transfer Mode) network, a SONET (Synchronous Optical Network) network, an SDH (Synchronous Digital Hierarchy) network, a wireless network and a wireline network. In some embodiments, the network 104 may comprise a wireless link, such as an infrared channel or satellite band. The topology of the network 104 may be a bus, star, or ring network topology. The network 104 may be of any such network topology as known to those ordinarily skilled in the art capable of supporting the operations described herein. The network may comprise mobile telephone networks utilizing any protocol or protocols used to communicate among mobile devices, including AMPS, TDMA, CDMA, GSM, GPRS, or UMTS. In some embodiments, different types of data may be transmitted via different protocols. In other embodiments, the same types of data may be transmitted via different protocols.

A client 102 and a remote machine 106 (referred to generally as computing devices 100) can be any workstation, desktop computer, laptop or notebook computer, server, portable computer, mobile telephone or other portable telecommunication device, media playing device, a gaming system, mobile computing device, or any other type and/or form of computing, telecommunications, or media device that is capable of communicating on any type and form of network and that has sufficient processor power and memory capacity to perform the operations described herein. A client 102 may execute, operate, or otherwise provide an application, which can be any type and/or form of software, program, or executable instructions, including, without limitation, any type and/or form of web browser, web-based client, client-server application, an ActiveX control, or a Java applet, or any other type and/or form of executable instructions capable of executing on client 102.

In one embodiment, a computing device 106 provides functionality of a web server. In some embodiments, a web server 106 comprises an open-source web server, such as the APACHE servers maintained by the Apache Software Foundation of Delaware. In other embodiments, the web server executes proprietary software, such as the Internet Information Services products provided by Microsoft Corporation of Redmond, Wash., the Oracle iPlanet web server products provided by Oracle Corporation of Redwood Shores, Calif., or the BEA WEBLOGIC products provided by BEA Systems of Santa Clara, Calif. In further embodiments, a computing device 106 executes self-replication software. In one of these embodiments, execution of the self-replication software allows a computing device 106a to direct a second computing device 106b to provide a copy of data stored by the computing device 106. For example, the computing device 106a may provide access to a web site and, upon execution of the self-replication software, direct the second computing device 106b to provide access to a copy of the web site.

In some embodiments, the system may include multiple, logically-grouped remote machines 106. In one of these embodiments, the logical group of remote machines may be referred to as a server farm 38. In another of these embodiments, the server farm 38 may be administered as a single entity.

FIGS. 1B and 1C depict block diagrams of a computing device 100 useful for practicing an embodiment of the client 102 or a remote machine 106. As shown in FIGS. 1B and 1C, each computing device 100 includes a central processing unit 121, and a main memory unit 122. As shown in FIG. 1B, a computing device 100 may include a storage device 128, an installation device 116, a network interface 118, an I/O controller 123, display devices 124a-n, a keyboard 126, a pointing device 127 (such as a mouse), and one or more other I/O devices 130a-n. The storage device 128 may include, without limitation, an operating system and software. As shown in FIG. 1C, each computing device 100 may also include additional optional elements, such as a memory port 103, a bridge 170, one or more input/output devices 130a-130n (generally referred to using reference numeral 130), and a cache memory 140 in communication with the central processing unit 121.

The central processing unit 121 is any logic circuitry that responds to and processes instructions fetched from the main memory unit 122. In many embodiments, the central processing unit 121 is provided by a microprocessor unit, such as: those manufactured by Intel Corporation of Mountain View, Calif.; those manufactured by Motorola Corporation of Schaumburg, Ill.; those manufactured by Transmeta Corporation of Santa Clara, Calif.; those manufactured by International Business Machines of White Plains, N.Y.; or those manufactured by Advanced Micro Devices of Sunnyvale, Calif. The computing device 100 may be based on any of these processors, or any other processor capable of operating as described herein.

Main memory unit 122 may be one or more memory chips capable of storing data and allowing any storage location to be directly accessed by the microprocessor 121. The main memory 122 may be based on any available memory chips capable of operating as described herein. In the embodiment shown in FIG. 1B, the processor 121 communicates with main memory 122 via a system bus 150. FIG. 1C depicts an embodiment of a computing device 100 in which the processor communicates directly with main memory 122 via a memory port 103. FIG. 1C also depicts an embodiment in which the main processor 121 communicates directly with cache memory 140 via a secondary bus, sometimes referred to as a backside bus. In other embodiments, the main processor 121 communicates with cache memory 140 using the system bus 150.

In the embodiment shown in FIG. 1B, the processor 121 communicates with various I/O devices 130 via a local system bus 150. Various buses may be used to connect the central processing unit 121 to any of the I/O devices 130, including a VESA VL bus, an ISA bus, an EISA bus, a MicroChannel Architecture (MCA) bus, a PCI bus, a PCI-X bus, a PCI-Express bus, or a NuBus. For embodiments in which the I/O device is a video display 124, the processor 121 may use an Advanced Graphics Port (AGP) to communicate with the display 124. FIG. 1C depicts an embodiment of a computer 100 in which the main processor 121 also communicates directly with an I/O device 130b via, for example, HYPERTRANSPORT, RAPIDIO, or INFINIBAND communications technology.

A wide variety of I/O devices 130a-130n may be present in the computing device 100. Input devices include keyboards, mice, trackpads, trackballs, microphones, scanners, cameras, and drawing tablets. Output devices include video displays, speakers, inkjet printers, laser printers, and dye-sublimation printers. An I/O controller 123 as shown in FIG. 1B may control the I/O devices. Furthermore, an I/O device may also provide storage and/or an installation device 116 for the computing device 100. In some embodiments, the computing device 100 may provide USB connections (not shown) to receive handheld USB storage devices such as the USB Flash Drive line of devices manufactured by Twintech Industry, Inc. of Los Alamitos, Calif.

Referring still to FIG. 1B, the computing device 100 may support any suitable installation device 116, such as a floppy disk drive for receiving floppy disks (such as 3.5-inch, 5.25-inch disks or ZIP disks), a CD-ROM drive, a CD-R/RW drive, a DVD-ROM drive, tape drives of various formats, USB device, hard-drive or any other device suitable for installing software and programs. The computing device 100 may further comprise a storage device, such as one or more hard disk drives or redundant arrays of independent disks, for storing an operating system and other software.

Furthermore, the computing device 100 may include a network interface 118 to interface to the network 104 through a variety of connections including, but not limited to, standard telephone lines, LAN or WAN links (e.g., 802.11, T1, T3, 56 kb, X.25, SNA, DECNET), broadband connections (e.g., ISDN, Frame Relay, ATM, Gigabit Ethernet, Ethernet-over-SONET), wireless connections, or some combination of any or all of the above. Connections can be established using a variety of communication protocols (e.g., TCP/IP, IPX, SPX, NetBIOS, Ethernet, ARCNET, SONET, SDH, Fiber Distributed Data Interface (FDDI), RS232, IEEE 802.11, IEEE 802.11a, IEEE 802.11b, IEEE 802.11g, IEEE 802.11n, CDMA, GSM, WiMax, and direct asynchronous connections). In one embodiment, the computing device 100 communicates with other computing devices 100′ via any type and/or form of gateway or tunneling protocol such as Secure Socket Layer (SSL) or Transport Layer Security (TLS). The network interface 118 may comprise a built-in network adapter, network interface card, PCMCIA network card, card bus network adapter, wireless network adapter, USB network adapter, modem, or any other device suitable for interfacing the computing device 100 to any type of network capable of communication and performing the operations described herein.

In some embodiments, the computing device 100 may comprise or be connected to multiple display devices 124a-124n, which each may be of the same or different type and/or form. As such, any of the I/O devices 130a-130n and/or the I/O controller 123 may comprise any type and/or form of suitable hardware, software, or combination of hardware and software to support, enable, or provide for the connection and use of multiple display devices 124a-124n by the computing device 100. One ordinarily skilled in the art will recognize and appreciate the various ways and embodiments that a computing device 100 may be configured to have multiple display devices 124a-124n.

In further embodiments, an I/O device 130 may be a bridge between the system bus 150 and an external communication bus, such as a USB bus, an Apple Desktop Bus, an RS-232 serial connection, a SCSI bus, a FireWire bus, a FireWire 800 bus, an Ethernet bus, an AppleTalk bus, a Gigabit Ethernet bus, an Asynchronous Transfer Mode bus, a HIPPI bus, a Super HIPPI bus, a SerialPlus bus, a SCI/LAMP bus, a FibreChannel bus, or a Serial Attached small computer system interface bus.

A computing device 100 of the sort depicted in FIGS. 1B and 1C typically operates under the control of operating systems, which control scheduling of tasks and access to system resources. The computing device 100 can be running any operating system such as any of the versions of the MICROSOFT WINDOWS operating systems, the different releases of the Unix and Linux operating systems, any version of the MAC OS for Macintosh computers, any embedded operating system, any real-time operating system, any open source operating system, any proprietary operating system, any operating systems for mobile computing devices, or any other operating system capable of running on the computing device and performing the operations described herein. Typical operating systems include, but are not limited to: WINDOWS 3.x, WINDOWS 95, WINDOWS 98, WINDOWS 2000, WINDOWS NT 3.51, WINDOWS NT 4.0, WINDOWS CE, WINDOWS XP, WINDOWS 7, and WINDOWS VISTA, all of which are manufactured by Microsoft Corporation of Redmond, Wash.; MAC OS, manufactured by Apple Inc. of Cupertino, Calif.; OS/2, manufactured by International Business Machines of Armonk, N.Y.; and Linux, a freely-available operating system distributed by Caldera Corp. of Salt Lake City, Utah, or any type and/or form of a Unix operating system, among others.

The computing device 100 can be any workstation, desktop computer, laptop or notebook computer, server, portable computer, mobile telephone or other portable telecommunication device, media playing device, a gaming system, mobile computing device, or any other type and/or form of computing, telecommunications, or media device that is capable of communication and that has sufficient processor power and memory capacity to perform the operations described herein. In some embodiments, the computing device 100 may have different processors, operating systems, and input devices consistent with the device. In other embodiments the computing device 100 is a mobile device, such as a JAVA-enabled cellular telephone or personal digital assistant (PDA). The computing device 100 may be a mobile device such as those manufactured, by way of example and without limitation, by Motorola Corp. of Schaumburg, Ill.; Kyocera of Kyoto, Japan; Samsung Electronics Co., Ltd. of Seoul, Korea; Nokia of Finland; Hewlett-Packard Development Company, L.P. and/or Palm, Inc. of Sunnyvale, Calif.; Sony Ericsson Mobile Communications AB of Lund, Sweden; or Research In Motion Limited of Waterloo, Ontario, Canada. In yet other embodiments, the computing device 100 is a smart phone, Pocket PC, Pocket PC Phone, or other portable mobile device supporting Microsoft Windows Mobile Software.

In some embodiments, the computing device 100 is a digital audio player. In one of these embodiments, the computing device 100 is a digital audio player such as the Apple IPOD, IPOD Touch, IPOD NANO, and IPOD SHUFFLE lines of devices, manufactured by Apple Inc. of Cupertino, Calif. In another of these embodiments, the digital audio player may function as both a portable media player and as a mass storage device. In other embodiments, the computing device 100 is a digital audio player such as those manufactured by, for example and without limitation, Samsung Electronics America of Ridgefield Park, N.J., Motorola Inc. of Schaumburg, Ill., or Creative Technologies Ltd. of Singapore. In yet other embodiments, the computing device 100 is a portable media player or digital audio player supporting file formats including, but not limited to, MP3, WAV, M4A/AAC, WMA Protected AAC, AEFF, Audible audiobook, Apple Lossless audio file formats and .mov, .m4v, and .mp4 MPEG-4 (H.264/MPEG-4 AVC) video file formats.

In some embodiments, the computing device 100 comprises a combination of devices, such as a mobile phone combined with a digital audio player or portable media player. In one of these embodiments, the computing device 100 is a device in the Motorola line of combination digital audio players and mobile phones. In another of these embodiments, the computing device 100 is a device in the iPhone smartphone line of devices, manufactured by Apple Inc. In still another of these embodiments, the computing device 100 is a device executing the Android open source mobile phone platform distributed by the Open Handset Alliance; for example, the device 100 may be a device such as those provided by Samsung Electronics, or HTC Headquarters of Taiwan, R.O.C. In other embodiments, the computing device 100 is a tablet device such as, for example and without limitation, the iPad line of devices, manufactured by Apple Inc.; the PlayBook, manufactured by Research in Motion; the Cruz line of devices, manufactured by Velocity Micro, Inc. of Richmond, Va.; the Folio and Thrive line of devices, manufactured by Toshiba America Information Systems, Inc. of Irvine, Calif.; the Galaxy line of devices, manufactured by Samsung; the HP Slate line of devices, manufactured by Hewlett-Packard; and the Streak line of devices, manufactured by Dell, Inc. of Round Rock, Tex.

Referring now to FIG. 1D, a block diagram depicts one embodiment of a system in which a plurality of networks provide hosting and delivery services. In brief overview, the system includes a cloud services and hosting infrastructure 180, a data center 182, and an information technology (IT) network 184.

In one embodiment, the data center 182 includes computing devices such as, without limitation, servers (including, for example, application servers, file servers, databases, and backup servers), routers, switches, and telecommunications equipment. In another embodiment, the cloud services and hosting infrastructure 180 provides access to, without limitation, storage systems, databases, application servers, desktop servers, directory services, web servers, as well as services for accessing remotely located hardware and software platforms. In still another embodiment, the cloud services and hosting infrastructure 180 includes a data center 182. In other embodiments, however, the cloud services and hosting infrastructure 180 relies on services provided by a third-party data center 182. In some embodiments, the IT network 104c may provide local services, such as mail services and web services. In other embodiments, the IT network 104c may provide local versions of remotely located services, such as locally-cached versions of remotely-located print servers, databases, application servers, desktop servers, directory services, and web servers. In further embodiments, additional servers may reside in the cloud services and hosting infrastructure 180, the data center 182, or other networks altogether, such as those provided by third-party service providers including, without limitation, infrastructure service providers, application service providers, platform service providers, tools service providers, and desktop service providers.

In one embodiment, a user of a client 102 accesses services provided by a remotely located server 106a. For instance, an administrator of an enterprise IT network 184 may determine that a user of the client 102a will access an application executing on a virtual machine executing on a remote server 106a. As another example, an individual user of a client 102b may use a resource provided to consumers by the remotely located server 106 (such as email, fax, voice or other communications service, data backup services, or other service).

As depicted in FIG. 1D, the data center 182 and the cloud services and hosting infrastructure 180 are remotely located from an individual or organization supported by the data center 182 and the cloud services and hosting infrastructure 180; for example, the data center 182 may reside on a first network 104a and the cloud services and hosting infrastructure 180 may reside on a second network 104b, while the IT network 184 is a separate, third network 104c. In other embodiments, the data center 182 and the cloud services and hosting infrastructure 180 reside on a first network 104a and the IT network 184 is a separate, second network 104c. In still other embodiments, the cloud services and hosting infrastructure 180 resides on a first network 104a while the data center 182 and the IT network 184 form a second network 104c. Although FIG. 1D depicts only one sever 106a, one server 106b, one server 106c, two clients 102, and three networks 104, it should be understood that the system may provide multiple ones of any or each of those components. The servers 106, clients 102, and networks 104 may be provided as described above in connection with FIGS. 1A-1C.

Therefore, in some embodiments, an IT infrastructure may extend from a first network—such as a network owned and managed by an individual or an enterprise—into a second network, which may be owned or managed by a separate entity than the entity owning or managing the first network. Resources provided by the second network may be said to be “in a cloud.” Cloud-resident elements may include, without limitation, storage devices, servers, databases, computing environments (including virtual machines, servers, and desktops), and applications. For example, the IT network 184 may use a remotely located data center 182 to store servers (including, for example, application servers, file servers, databases, and backup servers), routers, switches, and telecommunications equipment. The data center 182 may be owned and managed by the IT network 184 or a third-party service provider (including for example, a cloud services and hosting infrastructure provider) may provide access to a separate data center 182.

In some embodiments, one or more networks providing computing infrastructure on behalf of customers is referred to a cloud. In one of these embodiments, a system in which users of a first network access at least a second network including a pool of abstracted, scalable, and managed computing resources capable of hosting resources may be referred to as a cloud computing environment. In another of these embodiments, resources may include, without limitation, virtualization technology, data center resources, applications, and management tools. In some embodiments, Internet-based applications (which may be provided via a “software-as-a-service” model) may be referred to as cloud-based resources. In one of these embodiments, by way of example, cloud-based resources include functionality for storing data on a third-party server located in the cloud; by way of example, and without limitation, such services include those provided by Dropbox, Inc. of San Francisco, Calif.; Google, Inc. of Mountain View, Calif.; and Microsoft Corp. of Redmond, Wash. In other embodiments, networks that provide users with computing resources, such as remote servers, virtual machines, or blades on blade servers, may be referred to as compute clouds or “infrastructure-as-a-service” providers. In still other embodiments, networks that provide storage resources, such as storage area networks, may be referred to as storage clouds. In further embodiments, a resource may be cached in a local network and stored in a cloud.

In some embodiments, some or all of a plurality of remote machines 106 may be leased or rented from third-party companies such as, by way of example and without limitation, Amazon Web Services LLC of Seattle, Wash.; Rackspace US, Inc. of San Antonio, Tex.; Microsoft Corp. of Redmond, Wash.; and Google Inc. of Mountain View, Calif. In other embodiments, all the hosts 102 are owned and managed by third-party companies including, without limitation, Amazon Web Services LLC, Rackspace US, Inc., Microsoft, and Google.

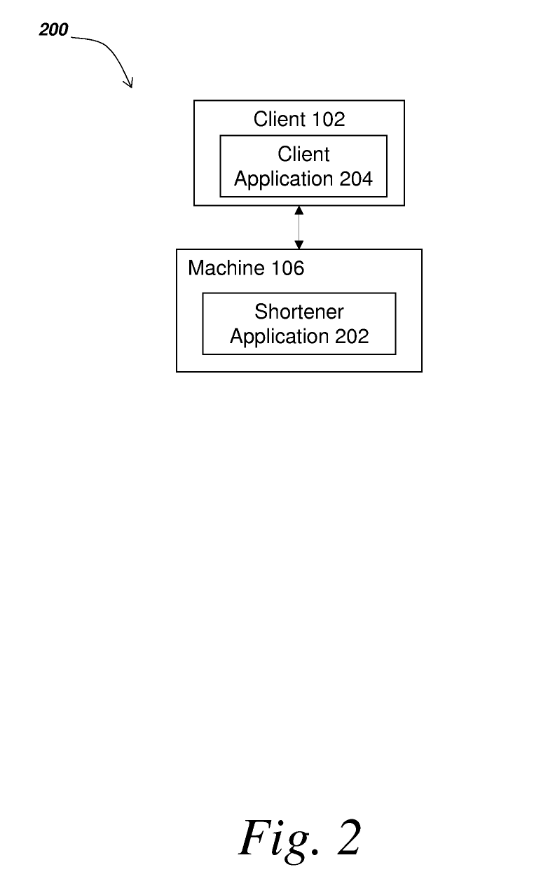

Referring now to FIG. 2, a block diagram depicts one embodiment of a system for identifying resource types within shortened uniform resource locators (URLs). In brief overview, the system includes a client 102, a machine 106, and a shortener application 202.

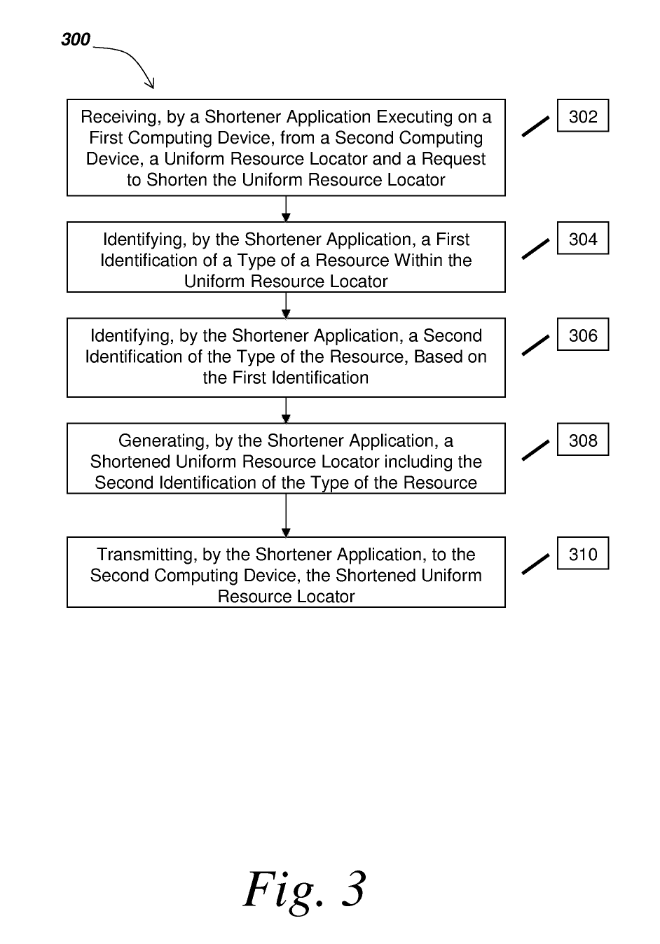

In one embodiment, the client 102 is provided as described in connection with FIGS. 1A-1D. In another embodiment, the client 102 executes a browser application to establish a connection with the machine 106. In still another embodiment, the client 102 executes a client application 204 that receives a URL from a user of the client 102 and transmits the URL to the machine 106 with a request to shorten the URL. In yet another embodiment, the client application 204 provides a user interface into which the user of the client 102 can provide the URL, as will be discussed in additional detail in connection with FIG. 3 below.

In one embodiment, the machine 106 is provided as described in connection with FIGS. 1A-1D. In another embodiment, the machine 106 executes the shortener application 202. In another embodiment, the machine 106 includes, or provides access to, a database (not shown) storing data generated by the shortener application 202.

In one embodiment, the shortener application 202 is a software application executing on the machine 106 (e.g., residing in storage 128). In another embodiment, the shortener application 202 is a hardware application executing on the machine 106. In still another embodiment, the shortener application 202 is a stand-alone application executing on the machine 106. In yet another embodiment, the shortener application 202 is a component of another application executing on the machine 106 (e.g., an add-on or plug-in component that extends the functionality of another application). In some embodiments, the shortener application 202 receives requests for shortening resources identified by the client 102, analyzes resource identifiers, and generates shortened resource identifiers.

In one embodiment, a uniform resource locator (URL) is a character string that, when provided to a browser application executing on a client 102, allows the client 102 to identify and establish a connection to a server 106 that makes the resource available to client machines. In another embodiment, a URL is provided as described in the Internet Engineering Task Force Request for Comments Memorandum 1738. In some embodiments, a user may interact with text or images in a first resource to access a second resource—for example, because the first resource (such as, for example, a web page or document written in a markup language such as the HyperText Markup Language or the eXtensible Markup Language)—includes text or images associated with a URL; such text or image may be referred to as a hyperlink or a link. In one of these embodiments the URL itself may be referred to as the link or hyperlink.

In some embodiments, in addition to identifying a location of a resource (e.g., an internet address for a machine 106 storing the resource), a URL includes a file path and a file name for the resource; further, the file name may include a base name and a filename extension. Filename extensions are typically separated from the base name by a period and may be of any length. Many filename extensions identify a file format of the resources—for example, and without limitation, the filename extension may indicate that the resource is a word processing document, a spreadsheet document, a presentation document, a portable document format, a compressed folder, a file containing source code, an executable application, or a media file (e.g., a file containing audio, video, or audiovisual data). Although many common filename extensions are three letters long (such as, for example, .doc, .ppt, .xls, .txt, .zip, and .xml), there is no limitation on how long or short the filename extension may be and some are longer than three characters (such as, for example, .java, .crdownload, and .accda) or shorter than three characters (such as, for example, .bi, .c, and .db).

Referring now to FIG. 3, a flow diagram depicts one embodiment of a method 300 for identifying resource types within shortened uniform resource locators. In brief overview, the method 300 includes receiving, by a shortener application executing on a first computing device, from a second computing device, a uniform resource locator and a request to shorten the URL (302). The method 300 includes identifying, by the shortener application, a first identification of a type of a resource within the uniform resource locator (304). The method 300 includes identifying, by the shortener application, a second identification of the type of the resource, based on the first identification (306). The method 300 includes generating, by the shortener application, a shortened uniform resource locator including the second identification of the type of the resource (308). The method 300 includes transmitting, by the shortener application, to the second computing device, the shortened uniform resource locator (310).

Referring now to FIG. 3 in greater detail, and in connection with FIG. 2, the shortener application 202 receives, from the client 102, a uniform resource locator and a request to shorten the uniform resource locator (302). In one embodiment, a user of the client 102 executes a browser application that connects to the shortener application 202 and the user provides the URL via, for example, a user interface on a web page provided by the shortener application 202, either as a stand-alone web page or as an interface embedded into a third-party web site; for instance, the user may type or paste the URL into a textbox within the user interface and then interact with a second interface element in the user interface to submit the URL to the shortener application 202. In another embodiment, the user of the client 102 executes an application that includes an interface for providing data to the shortener application 202, such as, for example, a word processing application or electronic mail application modified to include the interface and to transmit data received by the interface to the shortener application 202. In still another embodiment, the user interface allows the user to “drag and drop” the URL onto an active area of a display (e.g., a displayed desktop area) in order to trigger transmission of the URL to the shortener application 202.

In some embodiments, the received URL identifies a location of a resource stored by a third-party machine 106b (not shown). In one of these embodiments, by way of example, the received URL identifies a location of a resource stored by a cloud computing service, as discussed above in connection with FIG. 1D.

In other embodiments, the received URL identifies resources that are not executable files—for example, the user of the client 102 may submit a URL for shortening that is associated with a word processing document, media file, or spreadsheet file, but not an executable application.

The shortener application identifies a first identification of a type of the resource within the uniform resource locator (304). In one embodiment, the shortener application 202 analyzes the URL to identify the first identification; for example, the shortener application 202 may parse the URL to identify a filename and may parse the filename to identify a filename extension, which is, in this example, the first identification. In another embodiment, the shortener application 202 uses pattern matching to identify at least a portion of the URL that identifies the first identification of the type. In still another embodiment, the shortener application 202 uses regular expressions to search the URL for the first identifier. In yet another embodiment, by way of example and without limitation, the URL may be “Protocol//HostMachine.HostDomain/path1/path2/path3/BaseFileName.FilenameExtension” and the shortener application 202 determines that “FilenameExtension” identifies the type of the resource (e.g., a word processing document, an email, a media file, or a presentation).

In some embodiments, the shortener application 202 optionally provides additional security functionality. In one of these embodiments, by way of example, the shortener application 202 analyzes the first identification of the type of the resource to determine whether the file type is associated with malicious software; for example, the shortener application 202 may search lists of banned file types to determine whether the first identification indicates that the resource is a type of resource known to have unintended consequences for users (e.g., installation of viruses or direction to undesirable resources).

In some embodiments, the shortener application 202 determines that the URL does not include the first identification of the type of the resource. In one of these embodiments, the shortener application 202 transmits a request to the client 102 for a URL that does include an identification of a type of the resource. In another of these embodiments, the shortener application 202 rejects the request to shorten the first URL and then transmits the request to the client 102 for the URL that does include the identification of the type of the resource; such a request may take the form of a request that the user rename the resource so as to include the identifier. In other embodiments, the shortener application 202 attempts to determine the type of the resource without the first identification. In one of these embodiments, the URL does not include a filename extension, and the shortener application 202 includes functionality for identifying a file format of the resource without the extension. In another of these embodiments, the shortener application 202 includes functionality for analyzing the resource to identify the file format. In still another of these embodiments, the shortener application 202 retrieves a copy of the resource for analysis. In another of these embodiments, the shortener application 202 retrieves a portion of the resource for analysis. In yet another of these embodiments, the shortener application 202 analyzes a portion of the file to determine whether there is an identifier within the file. For example, particular patterns of hexadecimal digits within the file may identify the file format (and because of that, those digits are sometimes referred to by those of ordinary skill in the art as “magic numbers”); in other examples, and as will be understood by one of ordinary skill in the art, the shortener application 202 may analyze the file for other types of file signatures useful in identifying the type of the file. In another of these embodiments, the shortener application 202 performs this analysis even if the URL includes the first identification of the type of the resource; performing the analysis may confirm that the first identification of the type of the resource is accurate and was not manipulated by the user.

The shortener application identifies a second identification of the type of the resource, based on the first identification (306). In one embodiment, the second identifier is a character string (conventionally having 2-4 characters) identifying a file type that enables other computer applications to identify the resource. In another embodiment, the shortener application 202 identifies a second identifier that is substantially different from the first identifier; for example, the first identifier may be the string “spreadsheet” and the second identifier may be the string “.xls”. In another embodiment, the shortener application 202 identifies a second identifier that is substantially similar to the first identifier; for example, the first identifier may be the string “.docx” and the second identifier may be the string “.docx” or the string “.doc”. In still another embodiment, the shortener application 202 identifies a suffix associated with the first identification. In yet another embodiment, the shortener application 202 identifies a conventional suffix identifying the file type that may be concatenated onto a URL.

In one embodiment, to identify the second identifier of the type, the shortener application 202 performs a table lookup. In another embodiment, the shortener application 202 searches a file type association table containing a mapping between the first identifier of the type and the second identifier of the type. In still another embodiment, the shortener application 202 accesses metadata stored in a known location, such as a table located in a file containing a system database that maps associations between executable programs and data files or types of data files; for example, the file could be the registry on a WINDOWS system or a desktop file or property list on a MacOS system.

In some embodiments, where the URL does not include a filename extension and the shortener application 202 analyzes the resource to identify a type of the file, the shortener application 202 identifies the second identifier based on the analysis. In other embodiments, where the URL does not include a filename extension but the shortener application 202 does not analyze the resource to identify the type of the file, the shortener application 202 may assign an arbitrary second identifier. For example, and without limitation, in some instances there is a trust relationship established between an entity generating the original URL and an entity managing the shortener application 202 and in instances where the URL does not include an identifier of a file type, the shortener application 202 does not need to perform the analysis, instead assigning the arbitrary second identifier.

The shortener application generates a shortened uniform resource locator including the second identification of the type of the resource (308). In one embodiment, the shortener application 202 generates a shortened URL at a designated domain and including the second identification of the type of the resource. In another embodiment, the shortener application 202 confirms that the generated shortened URL is a unique URL that the shortener application 202 has not previously assigned to a different resource. In still another embodiment, the shortener application 202 concatenates a conventional file type suffix onto the shortened URL, thus identifying the file type both to human users who may view the shortened URL and to a computer application analyzing the URL to determine what application to execute in order to present the resource to a human user.

In some embodiments, the shortener application 202 uses HyperText Transfer Protocol (HTTP) redirection to associate a shortened URL with the received URL; for example, and as will be understood by those of ordinary skill in the art, the shortener application 202 may reserve a top-level domain having a short alphanumeric sequence, use the reserved domain name in generating shortened URLs, and associate the shortened URL with the received URL (e.g., and without limitation, by implementing a long URL recovery process, by using features such as modrewrite or .htaccess or other techniques understood by those of ordinary skill) However, unlike conventional systems, the shortener application 202 generates shortened URLs that include the second identification of the type of the resource.

In some embodiments, the shortener application 202 provides functionality allowing the user of the client 102 to propose a short name for the file, which is allowed provided the proposed short name has not already been assigned to a previously shortened URL. In one of these embodiments, the shortener application 202 may use the proposed short name but still includes the second identifier of the type of the resource.

In one embodiment, the received URL refers not to a web page or a single resource, but to a “folder” or collection of online resources. In such an embodiment, instead of including the second identifier of the type of a particular resource in the collection of resources, the shortener application 202 may include an indicator that the shortened URL refers to a collection of resources (e.g., by including a slash mark).

The shortener application transmits, to the second computing device, the shortened uniform resource locator (310). In one embodiment, the first computing device 106 transmits the shortened URL to the second computing device 102. In another embodiment, the first computing device 106 transmits the shortened URL to a third computing device 100 (e.g., a mobile device or other machine 100 associated with the user of the client 102 or to a second server 106b providing a service accessed by the user of the client 102, such as a microblogging service). In still another embodiment, the shortener application 202 places the shortened URL in a copy/pasted buffer of the client 102. In yet another embodiment, the user of the client 102 copies the shortened URL and pastes the shortened URL into a document for sharing with other users, either in electronic or paper format.

In some embodiments, in which the user of the client 102 places the plaintext of the shortened URL into a paper document (or a document in an electronic format that will later be printed out), the second identifier of the type of the resource remain readable by later readers and continues to identify the type of the resource for individuals who may later choose to type the shortened URL into their own clients 102.

In other embodiments, the shortener application 202 provides the client 102 with additional information associated with the shortened URL for display to the user. In one of these embodiments, when the shortened URL is pasted into an electronic document, the client 102 rendering the document may also receive from the shortener application 202 additional data for display in a context menu, rollover interface, or other commonly known interfaces for displaying additional data or metadata. In another of these embodiments, the additional information includes, without limitation, file size, the original URL, a result of scanning the resource by a virus/malware checker, and other data providing the user with information about the risks, if any, of accessing the resource.

In some embodiments, implementing the methods and systems described herein provides users with functionality for generating a shortened uniform resource locator that, while still shorter than an original uniform resource locator, includes a filename extension inherited from the original URL. In one of these embodiments, including the inherited filename extension is at odds with shortening the URL. However, and in another of these embodiments, the inheritance of the filename extension provides a viewer of the shortened uniform resource locator with confidence that he understands the type of the file, and therefore understands a property of the file, such as an application needed to process the file or a level of desirability of accessing the file.

It should be understood that the systems described above may provide multiple ones of any or each of these components and these components may be provided on either a standalone machine or, in some embodiments, on multiple machines in a distributed system. The phrases ‘in one embodiment,’ ‘in another embodiment,’ and the like, generally mean that the particular feature, structure, step, or characteristic following the phrase is included in at least one embodiment of the present disclosure and may be included in more than one embodiment of the present disclosure. However, such phrases do not necessarily refer to the same embodiment.

The systems and methods described above may be implemented as a method, apparatus, or article of manufacture using programming and/or engineering techniques to produce software, firmware, hardware, or any combination thereof. The techniques described above may be implemented in one or more computer programs executing on a programmable computer including a processor, a storage medium readable by the processor (including, for example, volatile and non-volatile memory and/or storage elements), at least one input device, and at least one output device. Program code may be applied to input entered using the input device to perform the functions described and to generate output. The output may be provided to one or more output devices.

Each computer program within the scope of the claims below may be implemented in any programming language, such as assembly language, machine language, a high-level procedural programming language, or an object-oriented programming language. The programming language may, for example, be LISP, PROLOG, PERL, PHP, Python, C, C++, C#, JAVA, or any compiled or interpreted programming language.

Each such computer program may be implemented in a computer program product tangibly embodied in a machine-readable storage device for execution by a computer processor. Method steps of the invention may be performed by a computer processor executing a program tangibly embodied on a computer-readable medium to perform functions of the invention by operating on input and generating output. Suitable processors include, by way of example, both general and special purpose microprocessors. Generally, the processor receives instructions and data from a read-only memory and/or a random access memory. Storage devices suitable for tangibly embodying computer program instructions include, for example, all forms of computer-readable devices, firmware, programmable logic, hardware (e.g., integrated circuit chip, electronic devices, a computer-readable non-volatile storage unit, non-volatile memory, such as semiconductor memory devices, including EPROM, EEPROM, and flash memory devices; magnetic disks such as internal hard disks and removable disks; magneto-optical disks; and CD-ROMs). Any of the foregoing may be supplemented by, or incorporated in, specially-designed ASICs (application-specific integrated circuits) or FPGAs (Field-Programmable Gate Arrays). A computer can generally also receive programs and data from a storage medium such as an internal disk (not shown) or a removable disk. These elements will also be found in a conventional desktop or workstation computer as well as other computers suitable for executing computer programs implementing the methods described herein, which may be used in conjunction with any digital print engine or marking engine, display monitor, or other raster output device capable of producing color or gray scale pixels on paper, film, display screen, or other output medium. A computer may also receive programs and data from a second computer providing access to the programs via a network transmission line, wireless transmission media, signals propagating through space, radio waves, infrared signals, etc.

Having described certain embodiments of methods and systems for generating shortened uniform resource locators including resource type identifiers, it will now become apparent to one of skill in the art that other embodiments incorporating the concepts of the disclosure may be used. Therefore, the disclosure should not be limited to certain embodiments, but rather should be limited only by the spirit and scope of the following claims.

What is claimed is:

1. A method comprising:
receiving, by a shortener application executing on a first computing device, from a second computing device, a uniform resource locator and a request to shorten the uniform resource locator;
identifying, by the shortener application, a first identification of a type of a resource within the uniform resource locator;
identifying, by the shortener application, a second identification of the type of the resource, based on the first identification;
generating, by the shortener application, a shortened uniform resource locator including the second identification of the type of the resource; and
transmitting, by the shortener application, to the second computing device, the shortened uniform resource locator.

2. The method of claim 1 further comprising providing, by the shortener application, a user interface with which to provide the uniform resource locator and the request to shorten the uniform resource locator.

3. The method of claim 1 further comprising providing, by the first computing device to the second computing device, an application with which a user of the second computing device provides the uniform resource locator and the request to shorten the uniform resource locator.

4. The method of claim 1, wherein identifying the first identification further comprises parsing the uniform resource locator to identify a filename within the uniform resource locator.

5. The method of claim 4 further comprising parsing the filename to identify the first identification of the type of the resource.

6. The method of claim 1, wherein identifying the first identification further comprises executing a pattern matching algorithm to identify at least a portion of the uniform resource locator that identifies the first identification of the type of the resource.

7. The method of claim 1, wherein identifying the first identification further comprises applying a regular expression to identify at least a portion of the uniform resource locator that identifies the first identification of the type of the resource.

8. The method of claim 1 further comprising determining, by the shortener application, whether the first identification of the type of the resource identifies a resource type associated with malicious software.

9. The method of claim 1 further comprising determining, by the shortener application, whether the first identification of the type of the resource identifies a resource type included in an enumeration of banned resource types.

10. The method of claim 1, wherein identifying the second identification further comprises identifying a resource type that enables other computer applications to identify the resource.

11. The method of claim 1, wherein identifying the second identification further comprises querying a database to identify an association between the first identification and the second identification.

12. The method of claim 1, wherein identifying the second identification further comprises querying a file type association table containing a mapping between the first identifier and the second identifier.

13. The method of claim 1, wherein generating the shortened uniform resource locator further comprises receiving, by the shortener application, from the second computing device, a proposed short name for inclusion in the shortened uniform resource locator.

14. A system comprising:
means for receiving, by a shortener application executing on a first computing device, from a second computing device, a uniform resource locator and a request to shorten the uniform resource locator;
means for identifying, by the shortener application, a first identification of a type of a resource within the uniform resource locator;
means for identifying, by the shortener application, a second identification of the type of the resource, based on the first identification;
means for generating, by the shortener application, a shortened uniform resource locator including the second identification of the type of the resource; and
means for transmitting, by the shortener application, to the second computing device, the shortened uniform resource locator.

15. The system of claim 14, wherein the means for identifying the first identification further comprises means for parsing the uniform resource locator to identify a filename within the uniform resource locator.

16. The system of claim 15 further comprising means for parsing the filename to identify the first identification of the type of the resource.

17. The system of claim 14, wherein the means for identifying the first identification further comprises means for executing a pattern matching algorithm to identify at least a portion of the uniform resource locator that identifies the first identification of the type of the resource.

18. The system of claim 14, wherein the means for identifying the first identification further comprises means for applying a regular expression to identify at least a portion of the uniform resource locator that identifies the first identification of the type of the resource.

19. The system of claim 14, wherein identifying the second identification further comprises querying a database to identify an association between the first identification and the second identification.

20. The system of claim 14, wherein the means for generating the shortened uniform resource locator further comprises means for receiving, by the shortener application, from the second computing device, a proposed short name for inclusion in the shortened uniform resource locator.
